(19) United States
(12) Patent Application Publication
(10) Pub. No.: US 2021/0233075 A1
(43) Pub. Date: Jul. 29, 2021

(54) DISTRIBUTED LEDGER

(71) Applicants: Andrew J. Shaevel, Amherst, NY (US); Michael Shvartsman, Novato, CA (US)

(72) Inventors: Andrew J. Shaevel, Amherst, NY (US); Michael Shvartsman, Novato, CA (US)

(21) Appl. No.: 17/132,401

(22) Filed: Dec. 23, 2020

Related U.S. Application Data
(60) Provisional application No. 62/953,380, filed on Dec. 24, 2019.

(51) Int. Cl. G06Q 20/40; G06F 16/27; G06Q 40/02

(52) U.S. Cl. CPC G06Q 20/401; G06F 16/27; G06Q 2220/00; G06Q 20/405; G06Q 40/02

(57) ABSTRACT

A debt registration system maintains the transactions of the buying and selling of debt using blockchain technology. A participant may register with the debt registration system, and the debt registration system may then validate the participant. The participant may then register a debt with the debt registration system. The debt registration system may be integrated with an accounting software platform, and may automatically register debts stored by a registered participant in the accounting software platform upon expiration of a predetermined time period. Using one or more blockchain technologies, the debt registration system then records and monitors transactions that occur relative to the registered debt. The debt registration system may further verify the transactions that involve the registered debt to ensure the accuracy and/or validity of such transactions. The blockchain corresponding to the debt may be distributed to one or more participants associated with the debt, such as debt originator, a debt buyer, a debt servicer, a regulator of debt, and the consumer that incurred the debt.

### CLAIM OF PRIORITY AND INCORPORATION BY REFERENCE

The present application claims the benefit under 35 U.S.C. § 119(e) of U.S. Provisional Patent Application 62/953,380, filed Dec. 24, 2019, entitled “DISTRIBUTED LEDGER,” the disclosure of which is hereby incorporated by reference herein in its entirety.

### TECHNICAL FIELD

The subject matter disclosed herein generally relates to systems and methods for implementing a distributed ledger and, in particular, to using a centralized verification system that implements the distributed ledger through blockchain technology.

### BACKGROUND

The distressed debt industry is riddled by fraud, inefficiency, and mistrust, which all translate into an economic cost to each and every market participant and transaction. These problems largely stem from the inability of industry participants to effectively validate their transactions and interactions. Portfolios are sold concurrently to multiple buyers, account information and balances are manipulated, and identities are stolen by bad actors who have access to consumers' sensitive data. Debt owners and debt servicers are not only at risk financially, but also with regard to the possibility of transacting with fraudulent consumer data. Consumers are routinely victimized because they have limited information about the details underlying on the debt which is being collected.

Furthermore, the current distressed debt ecosystem affects more than just the consumer—it hurts each party involved in the lifecycle of a debt, such as debt originators, debt owners, debt servicers, and other such parties. Creditors that write off bad debt (e.g., debt originators) have no easy way to ensure the data integrity of the debts after they are sold, which can subject them to reputational harm among their clients and customers, for example, when bad actors engage in unlawful collection practices. Moreover, debt buyers have no cost-effective way of authenticating the validity and chain of title of the debts offered for sale, making it challenging to ensure that the debt is still owed and, further, that the underlying details are accurate and have not been altered. These problems further exacerbate the problem of valuing the debts, as the uncertainty surrounding the validity and/or authenticity of the debt may affect its price. As such, a debt servicer (e.g., a debt collector) may not know with confidence whether they are the only servicer of record that is collecting on the debt portfolio.

### BRIEF DESCRIPTION OF THE DRAWINGS

Some embodiments are illustrated by way of example and not limitation in the figures of the accompanying drawings.

FIG. 1 is a diagram illustrating a networked system having a debt registration system, according to an example embodiment.

FIG. 2 is a diagram illustrating the debt registration system of FIG. 1 interacting with various blockchain nodes, according to an example embodiment.

FIG. 3 illustrates an example of the blockchain components of the debt registration system of FIG. 1, according to an example embodiment.

FIG. 4 illustrates the components of a blockchain node and primary ledger illustrated in FIG. 2, according to an example embodiment.

FIG. 5 illustrates a method, in accordance with an example embodiment, for registering a debt with the debt registration system illustrated in FIG. 1

FIG. 6 illustrates a method, in accordance with an example embodiment, for receiving and validating a payment on a debt by a debtor.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

Example methods and systems are directed to implementing a debt registry through blockchain technology that safely and securely monitors changes in a debt's owner, servicer, and balance, and which tracks each change and has the capability to record all correspondence and legal documents underlying each change as well as the original debt obligation. The disclosed systems and methods implement an accreditation process to ensure participants in the debt registry are properly licensed and credentialed, which provides confidence to various industry participants. The disclosed debt registry has numerous benefits to the various participants. For example, debt owners and/or debt servicers may have more confidence in the fidelity of the debt portfolios being bought and sold. In addition, a debt servicer may not have to spend as many resources (e.g., researching time, manpower, etc.) in preparing debts for servicing. As another example, a debt servicer can be assured that they are the only servicer of the debt, which addresses the problem of multiple servicers servicing the very same debt.

There are also benefits to the debtor. For example, a debtor will have more information about the details of his or her debt, such as who the debt owner is, who is the debt servicer authorized to collect on the debt, and a transaction history that includes payments received and fees/interest assessed. In addition, as each transaction is verified prior to being added to the transaction history, a debtor can be assured that the transaction was authorized and valid for a particular debt.

There are also benefits to debt originators and regulators. With regard to a debt originator, the disclosed systems and methods enable the implementation of various programmable and scalable safeguards to ensure that a debt portfolio is bought and/or sold with knowledge of the debt portfolio metrics and according to industry standards. In this way, the debt originator can be assured that a creditor's debt is not being sold to a debt owner that does not meet certain criteria. Finally, the disclosed systems and methods allow regulators viewable access to debt portfolios such that a regulator may follow the transactional history of the debt portfolio and knowledge regarding debt owners, debt servicers, creditors, and so forth, and their actions.

### Debt Registration System Overview

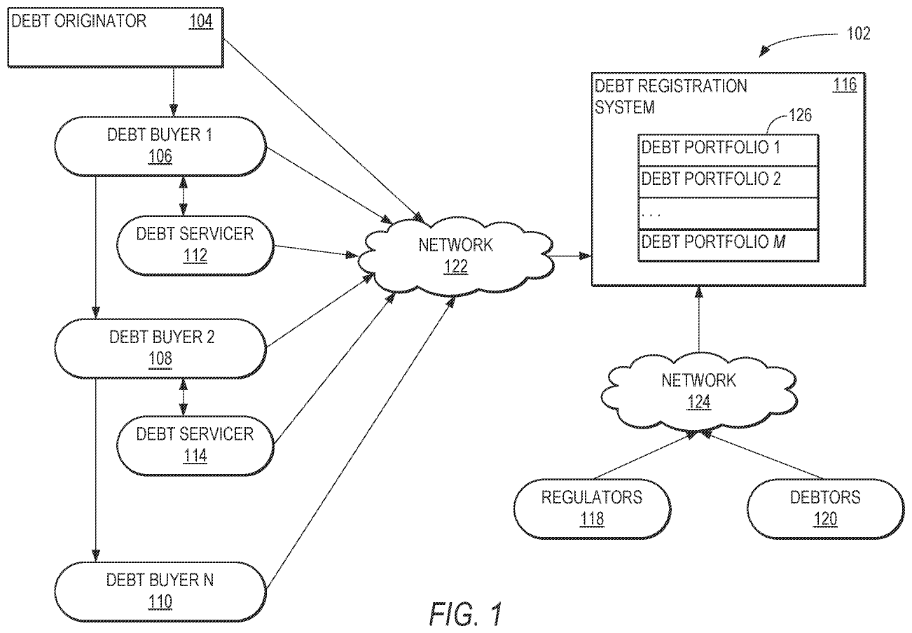

FIG. 1 is a diagram illustrating a networked system 102 having a debt registration system 116, according to an example embodiment. The debt registration system 116 provides server-side functionality via a network 122 to one or more debt originators (e.g., debt originator 104), debt buyers 106410, debt servicers 112-114. The debt registration system 116 also provides a secure access point for other participants over a network 124 for access by others, including, but not limited to regulators 118, and debtors 120. The various participants 104-114 and participants 118-120 may use one or more client devices to access and communicate with the debt registration system 116.

The client devices of the participants 104-114 and participants 118-120 may include, but are not limited to, a mobile phone, desktop computer, laptop, portable digital assistants (PDAs), smart phones, tablets, netbooks, laptops, multi-processor systems, microprocessor-based or programmable consumer electronics, or any other communication device that a user may utilize to access the debt registration system 116. In some embodiments, the client devices may comprise a display module (not shown) to display information (e.g., in the form of user interfaces).

Networks 122 and 124 may include one or more types of networks, such as an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks. In various embodiments, the network 122 includes the INTERNET. In various embodiments, the network 124 includes the INTERNET. In various embodiments, both networks 122 and 124 include the INTERNET. Accordingly, the access points and facilities for secure access may vary depending on the deployment of the present system. In various embodiments, separate access points may be used for enhanced security.

Further, while the client-server-based network architecture 102 shown in FIG. 1 employs a distributed, or peer-to-peer, architecture, the present subject matter is of course not limited to such an architecture. In various embodiments of the present subject matter a client-server architecture is employed, for example. Other topologies may be used without departing from the scope of the present subject matter.

The debt registration system 116 is configured to store and manage one or more debt portfolios 126. Each of the debt portfolios 126 may include one or more debts, and typically includes a plurality of debts. Each debt may be associated with one or more debt originators 104 and one or more debtors 120. The debt registration system 116 may store information about each debt including, but not limited to, a principal amount of the debt, an interest being charged for the debt, a payment schedule for the debt, a payment history for the debt, the debtors associated with the debt, the current debt servicer of the debt, and any other such information about the debt or about the participants involved with the debt. As discussed below, the debt registration system 116 may implement a blockchain technology to store the debt information. Further still, the debt registration system 116 may be configured to distribute a blockchain corresponding to a debt, a debt portfolio, or the entirety of the debt portfolios 126 depending on the implementation of the blockchain. In addition, the debt registration system 116 may be configured to validate a particular transaction for a debt before adding such transaction to the blockchain associated with the debt.

FIG. 1 illustrates that a debt originator 104 may communicate with the debt registration system 116 via the network 122. A debt originator 104 may include those entities (e.g., a creditor) that created a debt with a debtor 120. When the debt originator 104 has a debt that is past-due, it may start internal collection efforts to recoup the debt. Should these efforts fail, the debt originator 104 may charge-off the debt. A debt owner, which may be the originator 104, may elect to either place the debt for collection with a debt servicer, such as a debt servicers 112, or sell the debt to a debt buyer 106. When selling, debts are usually bundled with other charged-off debts in a distressed debt portfolio. When the distressed debt portfolio is purchased, the debt buyer will place the portfolio with a servicer to attempt to recoup its investment from the money owed on the underlying debts.

In addition, the debt registration system 116 of the present subject matter may be integrated with (and/or communicate with) one or more accounting software platforms used by a debt originator 104. An example of one such accounting software platform is QuickBooks®. Other accounting software platforms may be used without departing from the scope of the present subject matter. In various embodiments, a registered and/or validated debt originator 104 may agree (as part of the registration agreement of the debt originator) that a debt documented in the accounting software platform of the debt originator may be automatically added (and/or uploaded) to the debt registration system 116 upon expiration of a predetermined time period. For example, a debt owed to a registered debt originator is documented in the accounting software platform of the debt originator, and the debt originator has set their predetermined time period to be 120 days. In this example, if the debt remains unpaid after 120 days, the debt will be automatically added to the debt registration system.

In various embodiments, the debt registration system may be configured to aggregate any such automatically added debts, and to auction said aggregated debts in a debt marketplace, as described herein. A debt originator will thereby benefit by having smaller individual debts validated and aggregated, which will make them more marketable to a debt buyer 106. Likewise, the debt buyer 106 will benefit by being able to purchase a block of similar debt that has been verified using the systems and methods of the present subject matter. In various embodiments, a manager or owner of the debt registration system 116 may collect a percentage of the aggregated debt upon completion of the sale of said aggregated debt to a validated and/or registered debt buyer 106.

### Participant Registration

Participants have the ability to register with the debt registration system 116 so as to obtain access to select information depending on their status and role with the debt. This process may be performed using any of various secure authentication protocols, such as combining username and password login with other forms of authentication. In various embodiments a one-time code may be used. In various embodiments tokens may be used. In various embodiments the codes or tokens are delivered via diverse networks, including but not limited to email, phone, paging, wifi, and cellular systems. In various embodiments authentication is performed using one or more biometric identifiers, including but not limited to fingerprints, eye scanning, and facial recognition. In various embodiments, one or more of the foregoing authentication approaches may be used in a Multi-Factor Authentication (MFA). In various embodiments the system will incorporate various levels of verification of a participant registering on the system commensurate with the information they seek to access. For example, a debt originator must have secure access that is compliant with various financial regulatory requirements so as to ensure the security of any sensitive debt information stored and processed by the debt registration system 116. The various participants that register with the debt registration system 116 are validated for legitimacy of credentials and authority to participate. Once a participant is validated, it is then registered with the debt registration system 116, which creates an access point for market participants and enhances the veracity of the debt information and the underlying details for each participant as they interact with the system.

As part of the registration process, an entity may be asked to complete a debt registration profile and provide appropriate documentation to verify various bibliographical information, such as the entity's identity and background information and provide any licenses, any history of regulatory complaints, and/or any litigation or criminal convictions. This information may be verified by the debt registration system 116 using one or more processes, including manual review, an automated review (e.g., using API calls to third-party services, etc.), or a combination of the two. Where the registration of an entity is successful, the entity is considered Accredited and the debt registration profile is labeled as such.

The debt registration system 116 is highly programmable to facilitate secure registration of each potential participant. For example, the debt registration system 116 may be programmed to determine whether a debt originator 104 is accredited, and may block or control access by the debit originator 104 until such time as the system can verify that the debt originator 104 is accredited. The debt registration system 116 may prohibit or prevent the debt originator 104 from registering with the debt registration system 116 until the debt originator 104 becomes accredited. In various embodiments, the system 116 is programmable to provide access to the debt originator 104 that is enhanced upon verifying accreditation.

Although the foregoing example demonstrates that a debt originator 104 may register and may record debts with the debt registration system 116, the system 116 may support the registration of new participants, such as a debt buyer 106, a debt servicer 112, or a debtor 120. For each type of participant, the debt registration system 116 may request some form of accreditation or authorization prior to recording or accessing their debt record(s), and the process by which they are accepted to the system may vary.

### Debt Portfolio Generation and Controlled Access

An accredited participant may register a debt on the platform by uploading information about the debt. Such information may include account information, debt information, and underlying documentation (e.g., contracts, notes, etc.). For example, the participant may be required to provide documentation and/or certifications proving the existence of the debt and that the debt is valid. Accordingly, the participant may electronically send one or more of the requested documents to the debt registration system 116. The debt registration system 116 will create an electronic record corresponding to the debt, and may add the debt to a debt portfolio 126. In various embodiments the electronic record is an immutable blockchain entry. This form of recordation allows a complete and permanent transaction record to account for each activity of an account and of a portfolio.

Depending on the number of debts being registered with the debt registration system 116 by an entity, a debt portfolio 126 may include a single debt record or multiple debt records. Each debt portfolio will be accessible to the proper debt originator 104 participant and to debt servicers, such as debt collection agencies. The system 116 allows for customized access by all participants, such that a particular debt collector may be allowed controlled access to a portfolio of debt, a single debt record, or merely an item (e.g., a particular document or account balance) stored with the system 116, as determined by the debt originator or subsequent debt buyer/owner.

In some instances, a debt originator 104 (or other participant) may be unable to collect payment for a particular debt. Thus, the debt originator 104 may elect to charge-off the debt. Upon charge-off, the debt originator 104 may interact with the debt registration system 116 to record the charge-off and, in turn, the debt registration system 116 may request that the debt originator 104 upload documentation that provides support for the charge-off of the debt.

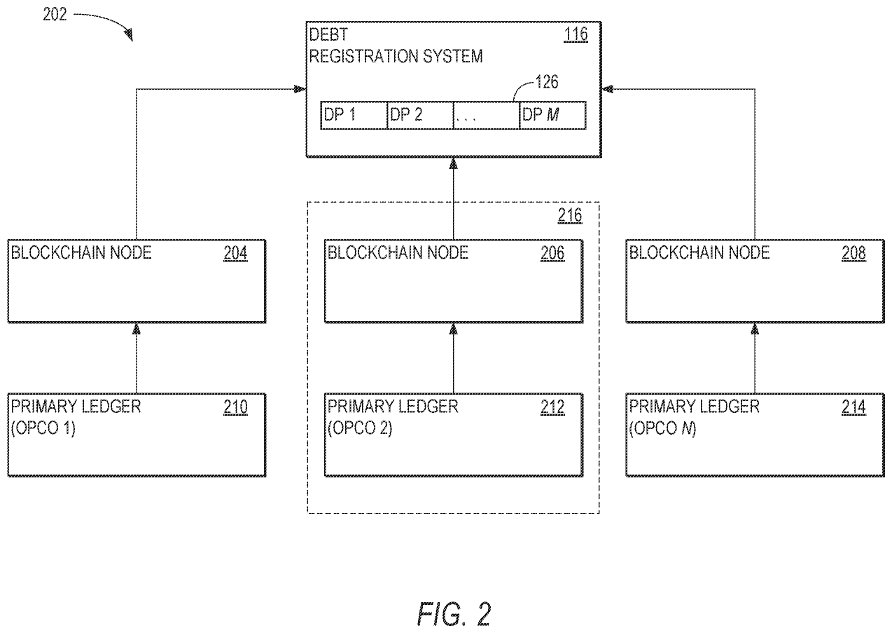

After a debt is registered, there may come a time when there is a change in ownership of the debt or the debt servicer for the debt. For example, as a debt portfolio 126 is bought and sold, the debt registration system 116 is updated with new records memorializing the change in ownership. The blockchain includes all of the original owner information and the new owner information is appended to maintain a complete and permanent record of each transaction, including ownership changes. If the new owner is not registered, such registration is conducted to gain access to the portfolio 126. Sale or related documentation is linked to the debt portfolio 126 within the debt registration system 116 to provide a thorough and complete record of the transfer of the debt portfolio 126. Upon completion of a change in ownership, which may occur outside of the debt registration system 116, the sale is logged in within the debt registration system 116, (discussed with reference to FIG. 2), and the debt registration system 116 grants access of the new debt information to the debt buyer, simultaneously revoking access from the debt seller. In various embodiments, a phase out of access is performed as the portfolio is transferred from one owner to the next. Such approaches allow for completion of various tasks and a more gradual transition of the debt portfolio to the new owner. The system 116 is highly programmable in that a former owner may be accorded limited access options to record communications with a debtor, to record payments received, or to record any other information after a date of sale in order to provide transparency in debt collections during a transition from the former owner to the present owner. This is but one example of the programmability and flexibility of the system 116 to demonstrate its use.

A similar process may occur when placing debt with a debt collector. A debt owner may only place debts with one debt collector at a time. As debt owners place debts with different debt collectors, the terms of the collection and/or collection agreement(s) are logged with the debt registration system 116, and the access rights are granted/revoked for each change. In various embodiments, the system 116 is programmable to employ smart contracts to ensure that the debts are never sold or placed with multiple buyers or debt servicers.

The debt registration system 116 further supports changes of debt balances. There are many different ways in which the balances can be adjusted up (e.g., fees and interest) and down (e.g., payments), each of which can be logged within the debt registration system 116. These balance adjustments are linked to the time, date, and associated organization that processed the change (e.g., the debt servicers or owner), and logged on the debt registration system, which information is in various embodiments recorded to the blockchain that undergirds the debt registration system. This creates a transparent ledger of all balance adjustments and responsible parties.

### Blockchain for Ledgers of the Debt Registration System

In various embodiments, the debt registration system 116 employs one or more blockchains to store and manage information in the system 116. FIG. 2 is a diagram 202 illustrating the debt registration system 116 of FIG. 1 interacting with various blockchain nodes 204-208, according to an example embodiment. In the illustrated embodiment, the debt registration system 116 shows a shared blockchain ledger with blockchain nodes 204-208. Each node 204-208 may include a copy of the ledger 210-214, and which is combined and distributed across all nodes to create a decentralized ledger. While the blockchain nodes 204-208 may be implemented as physical devices, the blockchain nodes may be implemented as virtual machines in the cloud. Each blockchain node 204-208 may also be associated with a node holder, such as an operating company (“OpCo”), that is responsible for what is written to the ledger from that node.

The debt portfolios 126 may be represented in a blockchain, where the genesis block of the blockchain represents the initial registration of a debt or a debt portfolio with the debt registration system 116. In various embodiments, the debt registration system 116 implements a single blockchain, where transactions that occur with the system 116 are verified by the system 116 and then added to the single blockchain to create a single immutable record of all transactions. Each block of this single blockchain may store information about a transaction, such as the type of transaction, any amounts of money exchanged in the transaction, the entities involved in the transaction, and other such transactional information. Furthermore, the data of the transaction is hashed such that the details of every document has a unique identifier on the blockchain. These hashes enable the authenticity of the data to be checked at a later date without exposing the actual contents. Each blockchain node 204-208 then updates their own respective ledger 210-214 with the added block. In this way, the blockchain of the debt registration system 116 is distributed across multiple blockchain nodes 204-208, where each blockchain node 204-208 may reference the single blockchain to verify the transactions that have occurred relative to a particular debt.

In another embodiment of the debt registration system 116, each debt portfolio and/or debt corresponds to a blockchain. Thus, the debt registration system 116 may manage multiple blockchains and distribute the blockchains based on the entities associated with the debt and/or debt portfolio. For example, the debt registration system 116 may distribute a first blockchain to the blockchain node 204 and a second blockchain to the blockchain node 206. where the first blockchain corresponds a particular debt portfolio or debt, and the second blockchain corresponds to another debt portfolio or debt. In some instances, a blockchain node may receive multiple blockchains, such as where the entity associated with the blockchain is associated with multiple debts or debt portfolios. In this alternative embodiment, a blockchain node may have access to view and/or verify each block of a blockchain node that was sent to it, as the entity associated with the blockchain node is presumably affiliated or associated with a debt or debt portfolio corresponding to the sent blockchain.

The blockchain examples provided here are intended to demonstrate the flexibility and programmability of the current system. Those of skill in the art of blockchain will appreciate that variations of blockchain storage may be employed without departing from the scope of the present subject matter.

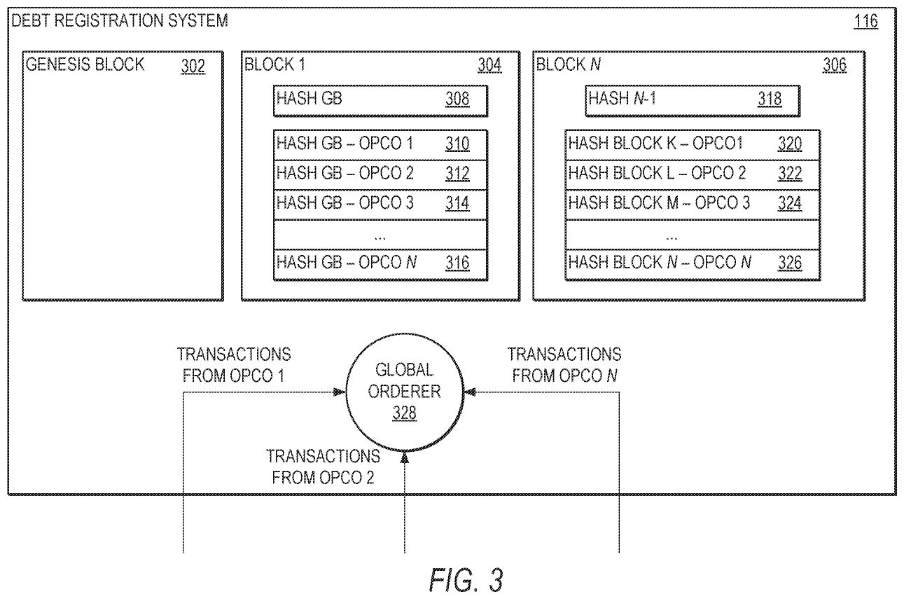

FIG. 3 illustrates an example of the blockchain components 302-328 of the debt registration system 116 of FIG. 1, according to an example embodiment. In various embodiments, the debt registration system 116 is implemented as a Software-as-a-Service (SaaS) solution using one or more different types of databases, such as Structured Query Language (SQL) database, a NoSQL database, other types of databases, or combinations thereof. The debt registration system 116 may implement one or more blockchain solutions, such as Hyperledger Fabric, the Credits Blockchain Platform, or any other distributed ledger solution, such as those developed using the DARPA Agent Markup Language (DAML). As a SaaS, the debt registration system 116 is available from any location or service that allows a network connection. Furthermore, because the debt registration system 116 is implemented as a SaaS, registrants with the debt registration system 116 do not have to maintain their own separate copy of their debt transactions, as such record keeping activities are performed by the debt registration system 116.

In one embodiment, the blockchain components 302-328 of the debt registration system 116 include a genesis block 302, one or more blockchain blocks 304-306, and a global orderer 328. In general, a genesis block is the first block of a blockchain. In some instances, the genesis block 302 is “hard coded” in the software of the applications that utilize its blockchain. Furthermore, typically the genesis block 302 may not reference a previous block. Subsequent blocks 304-306 may be derived from the genesis block 302. Each of the blocks 304-306 may include a cryptographic hash of the block that precedes it. Thus, block 304 includes a hash 308 of the genesis block, and block 306, which is the Nth block in the blockchain, includes a cryptographic hash 318 of the block that precedes it (e.g., block N-1).

In addition, each block 304-306 stores a sequence of transactions from OpCos that have registered with the debt registration system 116. Thus, block 304 includes transactions 310-316, and block 306 includes transactions 320-326. In one embodiment, the transactions 310-316 and the transactions 320-326 may be stored as cryptographic hashes of transactions that occurred at respective OpCos.

To manage the transactions from the various OpCos, the debt registration system 116 may include a global orderer 328. The global orderer 328 is configured to communicate with the various OpCos and to receive transactions from the OpCos. Additionally, and/or alternatively, the global orderer 328 may communicate to an OpCo whether a particular transaction was valid and, if the transaction was determined as being valid, whether the transaction was recorded in a particular block. Because the global orderer 328 is implemented as part of the SaaS model, the global orderer 328 may record transactions that occur from any location at any time.

When a transaction is received by the debt registration system 116, there may be a time delay between the time the transaction was received by the debt registration system 116 and the time a block of the blockchain associated with the debt is modified or added to reflect the transaction. There may be a time delay because the debt registration system 116 may be configured to verify and/or validate the details of the transaction. For example, where the transaction involves the sale of a debt, the debt registration system 116 may request that the debt buyer and/or the debt owner provide documentation (e.g., by uploading the documentation to the debt registration system 116) that verifies the details of the transaction, such as the parties to the transaction, the time of the transaction, the date of the transaction, the amounts involved in the transaction, and other such information.

The debt registration system 116 may be configured to validate and/or verify a transaction using one or more techniques. In one embodiment, the transaction is manually validated, whereby an administrator, user, or operator of the debt registration system 116 is notified to review the electronic documents provided to the debt registration system 116 in support of the transaction. In another embodiment, the transaction is validated automatically, whereby a program or machine processes the electronic document (e.g., using Optical Character Recognition, Natural Language Processing, etc.), and determines whether the information in the electronic document meets expected values (e.g., the parties, amounts, etc., identified in the transaction meet expected values). Where the transaction cannot be validated, the debt registration system 116 may reject the transaction and inform the party attempting to add the transaction of any deficiencies in the transaction (e.g., missing parties, missing values, incorrect information, etc.).

Alternatively, where the transaction is validated, the debt and/or debt portfolio corresponding to the transaction may be updated accordingly, and a new entry and/or new block may be added to the blockchain of the debt and/or debt portfolio corresponding to the transaction. In addition, the debt registration system 116 may disseminate the additional entry and/or block to other blockchain nodes 204-208. In various embodiments, the validated entry and/or block is disseminated to all blockchain nodes 204-208. In various embodiments, the validated entry and/or block is disseminated to particular or selected blockchain nodes, such as those that are associated with one or more parties to which the transaction pertains. Other update techniques may be applied without departing from the scope of the present subject matter.

In addition to transactions being added by a debt originator 104, the debt buyer 106, and the debt servicer 112, a debtor 120 may also perform a transaction that is added to the blockchain associated with the debt and/or debt portfolio. In various embodiments, the debt registration system 116 facilitates payments on the debt, such as by providing a graphical user interface (e.g., a webpage) that allows a debtor 120 to provide payment information and payment of a portion of a debt. Where a payment is directly received by the debt registration system 116 from a debtor 120, the debt registration system 116 may be configured to verify that the payment is valid (e.g., that the payment method provided is usable). Validating the payment may include validating that a provided credit card number is valid and usable or that a banking account has sufficient funds. While the debt registration system 116 may implement a payment mechanism for facilitating payments by a debtor 120, the debtor 120 may also pay a debt (or portion thereof) to another entity accredited by the debt registration system 116, such as the debt originator 104, the debt 106, the debt servicer 112, and so forth. Where the debtor 120 makes a payment to an entity other than the debt registration system 116, the debt registration system 116 may treat the payment as a transaction, and may validate the transaction as discussed above. In various applications of the present subject matter, the debt registration system 116 can be used by debt collectors to tender and record payments made directly to a debt collector or its agents. In various embodiments the tendered payments include an authorized push payment which may be a multi-factor authentication and/or a second party authentication. In various embodiments, the system 116 is configured to accept a number of payment types, such as one or more of ACH, credit push-payment, PayPal, wire transfer, or other known electronic payment modes. Those skilled in the art will appreciate that the secure payment can be recorded by the system and once verified, the payment information is added to the system's storage mechanism, such as a blockchain, to complete its immutable ledger of transactions, as described in various embodiments herein. Those skilled in the art will also recognize that different payment types may be employed to reduce payment charges and may have a different payment characteristic, depending on the payment mode. For example, traditional ACH payments may be disputed and may experience additional fees if the payment is not cleared, whereas a push payment may be performed without the same dispute risk and attendant charges. Those skilled in the art will appreciate the system can be modified as needed to facilitate other and new, future payment methodologies, and that the examples set forth here are not intended in an exclusive or exhaustive sense.

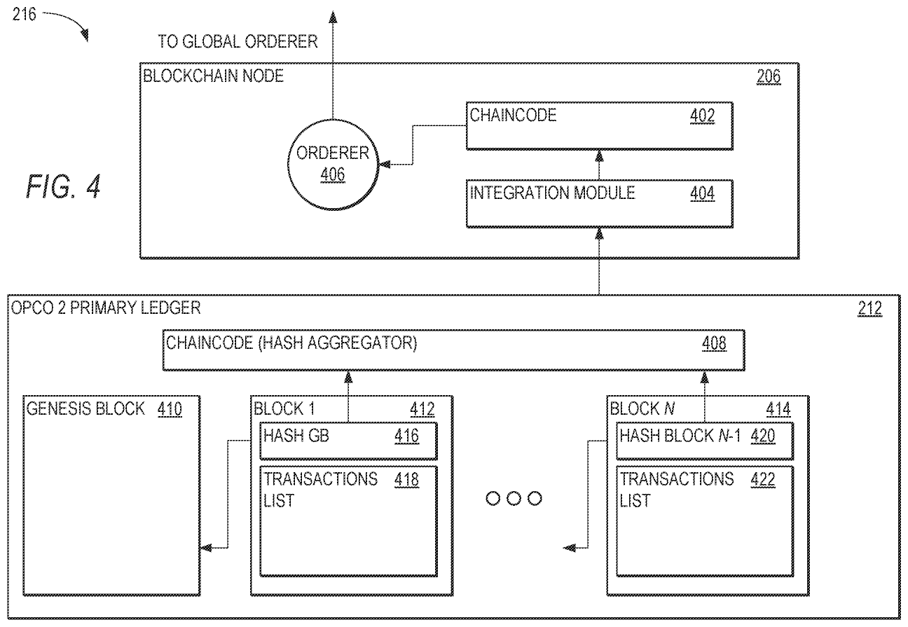

FIG. 4 illustrates the components of a blockchain node 206 and primary ledger 212 for a particular OpCo illustrated in FIG. 2, according to an example embodiment. The blockchain node 206 may include Chaincode 402, an integration module 404, and an orderer 406. Chaincode 402 may include one or more programs that run on top of the blockchain to implement the business logic of how applications interact with the primary ledger 212. When a transaction is proposed, the proposal triggers the chaincode 402 that decides what state change should be applied to the primary ledger 212.

The integration module 404 is configured to integrate the transactions of the primary ledger 212. In one embodiment, the integration module 404 includes one or more programs that implement logic of how the transactions integrate.

The primary ledger 212 includes those transactions that occurred relative to the genesis block 410. The primary ledger 212 includes one or more blocks 412-414 of the blockchain derived from the genesis block 410. Each block 412-414 may include a hash 416-420 of the block that precedes it, along with a transaction list 418-422 corresponding to the particular block. Chaincode 408 associated with the primary ledger 212 partitions the data stored by the primary ledger 212, similar to how records are partitioned by tables in a relational database.

When the OpCo engages in a transaction, such as the buying or selling of a debt, the transaction is registered to a particular block, such as block 412 or block 414. When a block reaches a predetermined size, such as 1 MB, a new block is created and added to the blockchain. The transactions performed by the OpCo may then be communicated and synchronized with the debt registration system 116 and via the global orderer 328. Because the debt registration system 116 is implemented as a SaaS solution, the OpCo may record the transactions at any time and regardless of the location of where the transaction occurred.

To communicate with the global orderer 328, the OpCo may be associated with a particular channel. In one embodiment, a channel is a confidentiality construct that provides partitioning of messages between users. In this context, the partitioning ensures that only those users specified as part of the channel's consortium will receive inputs and updates to the data (e.g., the blockchain and/or transactions). The channel may also ensure the segregation of data such that only channel users maintain the primary ledger 212 which is similar to separate relational database schemas. Each channel of the OpCo may be associated with an orderer 406, where the orderer 406 orders transactions and maintains versioning of data to prevent “double spend.”

### Participant Communications and Dispute Resolution

In some instances, the debt registration system 116 may receive a communication from a debtor 120 that a particular debt is not accurate or valid. In this regard, the debt registration system 116 may request that debtor 120 provide an explanation detailing why the debt is not accurate or valid. The debt registration system 116 may also request that the debtor 120 provide any supporting documentation that supports the debtor's claim. Where the debt registration system 116 determines that the complaint by the debtor 120 has merit (e.g., through a manual review, automatic review, or both), the debt registration system 116 may then request that the debt originator 104, the debt buyer 106, and/or debt servicer 112, provide proof (e.g., documentation) demonstrating that the debt is valid. Where the debt originator 104, the debt buyer 106, and/or debt servicer 112 cannot provide such documentation or fail to provide such documentation within a predetermined time period, the debt registration system 116 may identify the debt as being in dispute and may further suspend all transactions relative to the debt. It can store all notes and documentation of the resolution for later inspection.

The debt registration system 116 may store one or more debt registration profiles (not shown) of each party to a debt, such as the debt originator 104, the debt buyer 106, the debt servicer 112, the debtor 120, and so forth. The debt registration system 116 may then allow particular participants to review and/or comment on other participants. For example, the debt registration system 116 may allow a debtor 120 to provide feedback or comments for a debt servicer 112. The feedback and/or comments may become a part of the debt registration profile for the particular party. In various embodiments, the information can be made publicly accessible and may be anonymized to ensure that the specific participants are not identified to the public. Thus, the system 116 allows a ranking of all participants of the system 116. The system 116 also allows for other disputes to be raised and resolved by the various participants.

### Data Maintenance and Logging

The system 116 allows for ongoing maintenance and logging of collection data. The data in the various debt portfolios can be monitored for collections compliance and for integrity of the data stored. Such data analytics can be anonymized so that individual account information is kept secret. The data can be analyzed to spot trends in debt collection and debt management. Various forms of automated monitoring of the data in the system can be employed using smart programs. In various embodiments, artificial intelligence is used to determine trends, errors, and system failures. The blockchain embodiments also provide a platform for which automated hots and artificial intelligence algorithms can be used to process the data for future collections and for improved metrics of any portfolio or portfolio entry.

### Debt Transaction Examples

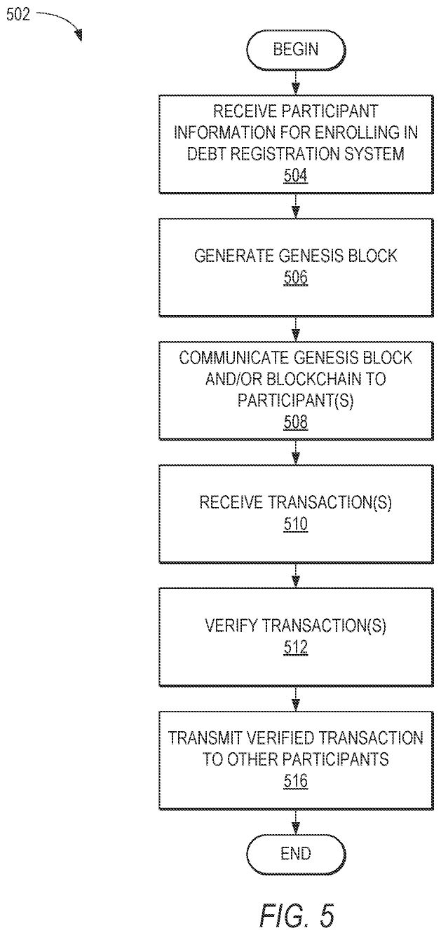

FIG. 5 illustrates a method 502, in accordance with an example embodiment, for registering a debt with the debt registration system 116 illustrated in FIG. 1. The method 502 may be implemented by the debt registration system 116 illustrated in FIG. 1 and is discussed by way of reference thereto.

Initially, the debt registration system 116 receives participant information for enrolling or registering a participant with the debt registration system 116. (Operation 504). The participant may include a debt originator 104, a debt buyer 106, a debt servicer 112, a regulator 118, a debtor 120. or any other entity. Where the participant is a debt originator 104 that desires to add a new debt to the debt registration system 116, the debt registration system 116 may generate a new genesis block for the debt (e.g., genesis block 302). The genesis block may then be distributed to one or more participants that interact with the debt (Operation 508). For example, the genesis block may be initially communicated to the participant that registers the debt. As the debt registration system 116 may be implemented as a SaaS solution, participants of the debt registration system 116 may not have to maintain their own records of a debt or its corresponding transactions as such maintenance and recordation activities may be performed by the debt registration system 116.

The debt registration system 116 may then process transaction(s) that occur relative to the registered debt (Operation 510). As mentioned previously, the transaction(s) may include the buying and/or selling of the debt to one or more entities. The debt registration system 116 may then verify the transaction (Operation 512). The debt registration system 116 may verify the transaction to ensure that false or fraudulent transactions are not being added to the blockchain corresponding to the registered debt. Once the transaction is verified, the debt registration system 116 may then transmit the verified transaction to other participants associated with the registered debt, such as the debtor 120 and/or the regulator 118 (Operation 516). In one embodiment, the transmission of the verified transaction is automatically performed by the debt registration system 116 upon the successful determination that the transaction was authentic and/or verified. Additionally, and/or alternatively, the debt registration system 116 may communicate the block of the blockchain corresponding to the verified transaction to the other participants associated with the debt. As the debt registration system 116 may be implemented as a SaaS solution, the transmission of the verified transactions may occur without the involvement of a participant or regardless of where participant is located.

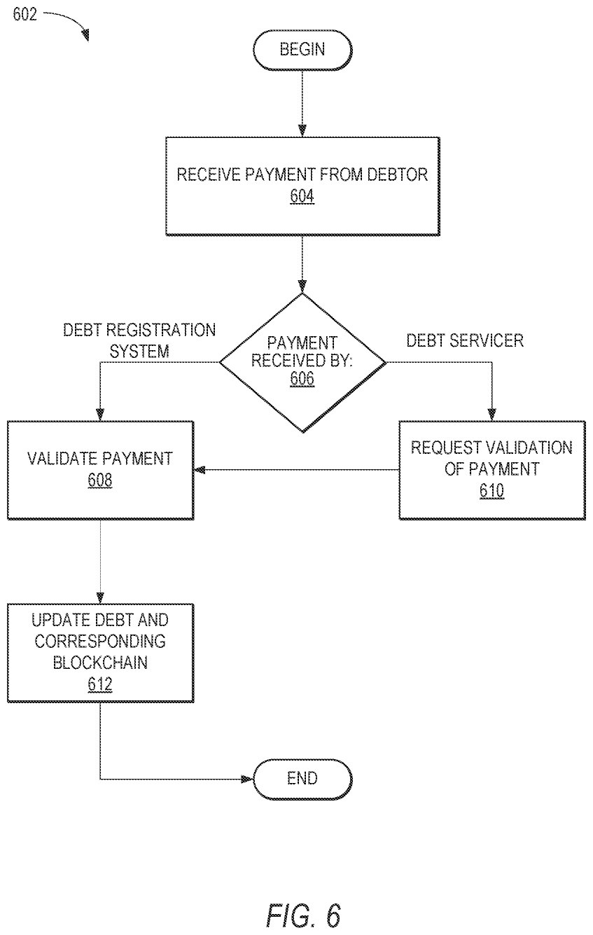

FIG. 6 illustrates a method 602, in accordance with an example embodiment, for receiving and validating a payment on a debt by a debtor. The method 602 may be implemented by one or more of the components illustrated in FIGS. 1-4 and discussed by way of reference thereto.

A debtor, such as a debtor 120, may initially make a payment on a debt (Operation 604). A determination is then made as to whether the payment was received by the debt registration system 116 or a debt servicer, such as debt servicer 112 (Operation 606). Where the payment is received by a debt servicer, the debt servicer may request validation of the payment (Operation 610). Alternatively, where the payment is received by the debt registration system 116, the debt registration system 116 may automatically validate the debt (Operation 608). As discussed above, the validation of the payment may be performed via a manually process, an automatic process, or both. Where the payment is validated, the debt registration system 116 may then update the debt based on the provided payment and update the blockchain associated with the debt (Operation 612). Where the validation of the payment was requested by the debt servicer, the debt registration system 116 may communicate to the debt servicer whether the payment was validated.

In this manner, the disclosed systems and methods implement a debt registration system to ensure the accuracy and transparency of the distressed debt industry. By using blockchain technology, the disclosed debt registration system 116 ensures that transactions involving the buying, selling, and collecting of debt is transparent to all parties involved with the debt who have permission to view and interact with the data.

In various of the foregoing embodiments, encryption may be used to store information when additional security of that information is desired. In various embodiments, additional encryption may he used to selectively protect records stored in one or more blockchain storages to control access of highly protected information and give that access only to those to whom access is desired. In various embodiments, public versions of data may be provided to allow for viewing, but with select information protected by encryption as desired, In various embodiments the blockchain data is made publicly available but only users with an encryption code or encryption key can view the underlying data. In various embodiments, encryption is used to provide limited or hierarchical access to one or more records according an encryption schema. Persons of skill in the art understand that various encryption approaches may be used to secure individual records, portions of records, or entire blockchain storages within the scope of the present subject matter. Thus, encryption allows yet another approach to secure, controlled, and highly configurable and programmable access of information in an immutable ledger.

### EXAMPLES

An example (e.g. “Example 1”) of a_distributed ledger, blockchain storage system for secure transactions may include_at least one blockchain storage module, providing storage of a plurality of loan transaction parameters for a plurality of consumers, the storage module providing for a configurable blockchain record per each consumer and per each loan to store loan transaction data and underlying records for the loan. The system may further include a secure access point for enrolling and registering participants and providing access to information from the blockchain storage module based on permissions granted to each enrolled and registered participant. The system may also include_an input and output validation module, configured to ensure information provided to the blockchain is valid per a pre-established set of rules and to generate outputs indicating validity and to calculate amounts of loan debt due, wherein the system is configured to allow each enrolled and registered participant to access certain information curated by the blockchain storage module for the purposes of servicing debts recorded by the system.

In Example 2, the subject matter of Example 1 may optionally be configured such that_the system resides on a server on a network accessible by the participants.

In Example 3, the subject matter of Example 2 may optionally be configured such that the network is the INTERNET.

In Example 4, the subject matter of any one or any combination of Examples 1-3 may optionally be configured such that the system includes an access point for consumers to securely review debt information and to securely tender payments.

In Example 5, the subject matter of any one or any combination of Examples 1-4 may optionally be configured such that the system provides an access point for authorized debt servicers to retrieve debt information from the system and to provide debt collection information to the system per each record in a debt portfolio.

An example (e.g. “Example 6”) of a method for securing transactions may include storing a configurable blockchain record for a consumer and for loan to store loan transaction data and underlying records for the loan. The method may further include enrolling and registering participants and providing access to information based on permissions granted to each validated participant. The method may also include ensuring information provided to the blockchain is valid per a pre-established set of rules, and generating outputs indicating validity. The method may further include calculating amounts of loan debt due, wherein enrolled and registered participants are allowed to access certain information for the purposes of servicing recorded debts.

In Example 7, the subject matter of Example 6 may optionally be configured such that the method is implemented on a server on a network accessible by the participants.

In Example 8, the subject matter of Example 7 may optionally be configured such that the network is the INTERNET.

In Example 9, the subject matter of any one or any combination of Examples 6-8 may optionally be configured such that the method further includes providing consumers with access to securely review debt information and to securely tender payments.

In Example 10, the subject matter of any one or any combination of Examples 6-9 may optionally be configured such that the method further includes providing an access point for authorized debt servicers to retrieve debt information from the configurable blockchain record and to provide debt collection information to the system per each record in a debt portfolio.

In Example 11, the subject matter of any one or any combination of Examples 6-10 may optionally be configured such that the method further includes integrating the configurable blockchain record with an accounting software platform used by an enrolled and registered debt originator, the accounting software platform storing information regarding outstanding debts, and automatically recording the outstanding debts in the configurable blockchain record after expiration of a predetermined time period.

In Example 12, the subject matter of Example 11 may optionally be configured such that the method includes obtaining an agreement from the enrolled and registered debt originator, upon enrollment and registration, that all debts stored in the accounting software platform are subject to automatic recording after expiration of the predetermined time period.

In Example 13, the subject matter of Example 12 may optionally be configured such that the method includes receiving from the enrolled and registered debt originator, upon enrollment and registration, a selection of a duration of the predetermined time period.

In Example 14, the subject matter of any one or any combination of Examples 11-13 may optionally be configured such that the method further includes aggregating the recorded outstanding debts using the configurable block chain.

In Example 15, the subject matter of Example 14 may optionally be configured such that the method further includes marketing the aggregated recorded outstanding debts to one or more enrolled and registered debt buyers using an auction format.

An example (e.g. “Example 16”) of a method may include integrating a debt collection and distribution service with an accounting software platform, the debt collection and distribution service including a configurable blockchain record. The method may further include enrolling a debt originator in the debt collection and distribution service, including obtaining an agreement from the debt originator that all outstanding debts stored by the debt originator in the accounting software platform are subject to automatic recording in the configurable blockchain record after expiration of a predetermined time period. The method may also include automatically recording the outstanding debts in the configurable blockchain record after expiration of the predetermined time period.

In Example 17, the subject matter of Example 16 may optionally be configured such that the method further includes aggregating the recorded outstanding debts using the configurable block chain.

In Example 18, the subject matter of Example 17 may optionally be configured such that the method further includes marketing the aggregated recorded outstanding debts to an enrolled and registered debt buyer using an auction.

In Example 19, the subject matter of Example 18 may optionally be configured such that the method further includes selling the aggregated recorded outstanding debts to the enrolled and registered debt buyer upon completion of the auction.

In Example 20, the subject matter of Example 19 may optionally be configured such that the method further includes providing access to the configurable blockchain to the enrolled and registered debt buyer upon completion of the sale of the aggregated recorded outstanding debts.

### Modules, Components, And Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine And Software Architecture

The modules, methods, applications and so forth described in conjunction with FIGS. 1-5 are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

### Example Machine Architecture And Machine-Readable Medium

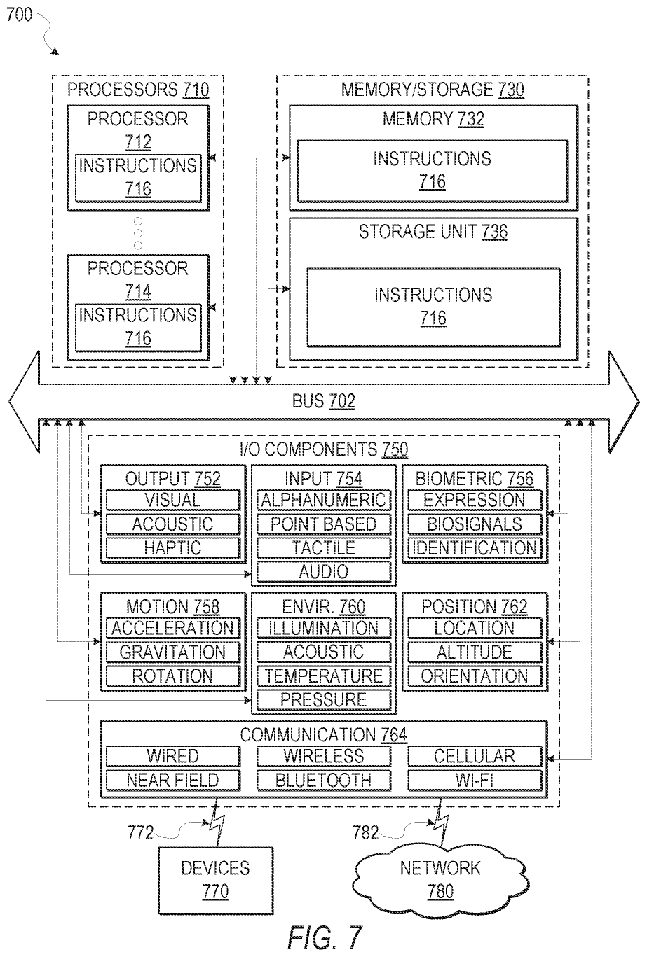

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example the instructions may cause the machine to execute the flow diagrams of FIGS. 5-6. Additionally, or alternatively, the instructions may implement one or more of the devices and/or components of FIGS. 1-4. The instructions transform the general, non-programmed machine into a particular machine programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a personal digital assistant (PDA), or any machine capable of executing the instructions 716, sequentially or otherwise, that specify actions to be taken by machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other such as via a bus 702. In an example embodiment, the processors 710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RTIC), another processor, or any suitable combination thereof) may include, for example, processor 712 and processor 714 that may execute instructions 716. The term “processor” is intended to include multi-core processor that may comprise two or more independent processors (sometimes referred to as “cores”) that may execute instructions contemporaneously. Although FIG. 7 shows multiple processors, the machine 700 may include a single processor with a single core, a single processor with multiple cores (e.g., a multi-core process), multiple processors with a single core, multiple processors with multiples cores, or any combination thereof.

The memory/storage 730 may include a memory 732, such as a main memory, or other memory storage, and a storage unit 736, both accessible to the processors 710 such as via the bus 702. The storage unit 736 and memory 732 store the instructions 716 embodying any one or more of the methodologies or functions described herein. The instructions 716 may also reside, completely or partially, within the memory 732, within the storage unit 736, within at least one of the processors 710 (e.g., within the processor's cache memory), or any suitable combination thereof, during execution thereof by the machine 700. Accordingly, the memory 732, the storage unit 736, and the memory of processors 710 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 716. The term “machine-readable medium” shall also be taken to include any medium, or combination of multiple media, that is capable of storing instructions (e.g., instructions 716) for execution by a machine (e.g., machine 700), such that the instructions, when executed by one or more processors of the machine 700 (e.g., processors 710), cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion and the grouping is in no way limiting. In various example embodiments, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumetic input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762 among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 may include acceleration sensor components e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 762 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via coupling 782 and coupling 772 respectively. For example, the communication components 764 may include a network interface component or other suitable device to interface with the network 780. In further examples, communication components 764 may include wired communication components, wireless communication components, cellular communication components, Near Field Communication (NEC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a Universal Serial Bus (USB)).

Moreover, the communication components 764 may detect identifiers or include components operable to detect identifiers. For example, the communication components 764 may include Radio Frequency Identification (RFID) tag reader components, NEC smart tag detection components, optical reader components (e.g., an optical sensor to detect one-dimensional bar codes such as Universal Product Code (LTC) bar code, multi-dimensional bar codes such as Quick Response (QR) code, Aztec code, Data Matrix, Dataglyph, MaxiCode, PDF-413, Ultra Code, UCC RSS-2D bar code, and other optical codes), or acoustic detection components (e.g., microphones to identify tagged audio signals). In addition, a variety of information may be derived via the communication components 764, such as, location via Internet Protocol (IP) geo-location, location via Wi-Fi® signal triangulation, location via detecting a NEC beacon signal that may indicate a particular location, and so forth.

### Transmission Medium

In various example embodiments, one or more portions of the network 780 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network and the coupling 782 may be a Code Division Multiple Access (CDMA) connection, a Global System for Mobile communications (GSM) connection, or other type of cellular or wireless coupling. In this example, the coupling 782 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 716 may he transmitted or received over the network 780 using a transmission medium via a network interface device e.g., a network interface component included in the communication components 764) and utilizing any one of a number of well-known transfer protocols (e.g., hypertext transfer protocol (HTTP)). Similarly, the instructions 716 may be transmitted or received using a transmission medium via the coupling 772 (e.g., a peer-to-peer coupling) to devices 770. The term “transmission medium” shall be taken to include any intangible medium that is capable of storing, encoding, or carrying instructions 716 for execution by the machine 700, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

We claim:

1. A distributed ledger, blockchain storage system for secure transactions, comprising:
at least one blockchain storage module, providing storage of a plurality of loan transaction parameters for a plurality of consumers, the storage module providing for a configurable blockchain record per each consumer and per each loan to store loan transaction data and underlying records for the loan;
a secure access point for enrolling and registering participants and providing access to information from the blockchain storage module based on permissions granted to each enrolled and registered participant; and
an input and output validation module, configured to ensure information provided to the blockchain is valid per a pre-established set of rules and to generate outputs indicating validity and to calculate amounts of loan debt due, wherein the system is configured to allow each enrolled and registered participant to access certain information curated by the blockchain storage module for the purposes of servicing debts recorded by the system.

2. The system of claim 1, wherein the system resides on a server on a network accessible by the participants.

3. The system of claim 2, wherein the network is the INTERNET.

4. The system of claim 1, wherein the system includes an access point for consumers to securely review debt information and to securely tender payments.

5. The system of claim 1, wherein the system provides an access point for authorized debt servicers to retrieve debt information from the system and to provide debt collection information to the system per each record in a debt portfolio.

6. A method for securing transactions, the method comprising:
storing a configurable blockchain record for a consumer and for loan to store loan transaction data and underlying records for the loan;
enrolling and registering participants and providing access to information based on permissions granted to each validated participant;
ensuring information provided to the blockchain is valid per a pre-established set of rules;
generating outputs indicating validity; and
calculating amounts of loan debt due, wherein enrolled and registered participants are allowed to access certain information for the purposes of servicing recorded debts.

7. The method of claim 6, wherein the method is implemented on a server on a network accessible by the participants.

8. The method of claim 7, wherein the network is the INTERNET.

9. The method of claim 6, further comprising:
providing consumers with access to securely review debt information and to securely tender payments.

10. The method of claim 6, further comprising:
providing an access point for authorized debt servicers to retrieve debt information from the configurable blockchain record and to provide debt collection information to the system per each record in a debt portfolio.

11. The method of claim 6, further comprising:
integrating the configurable blockchain record with an accounting software platform used by an enrolled and registered debt originator, the accounting software platform storing information regarding outstanding debts; and
automatically recording the outstanding debts in the configurable blockchain record after expiration of a predetermined time period.

12. The method of claim 11, comprising:
obtaining an agreement from the enrolled and registered debt originator, upon enrollment and registration, that all debts stored in the accounting software platform are subject to automatic recording after expiration of the predetermined time period.

13. The method of claim 12, comprising:
receiving from the enrolled and registered debt originator, upon enrollment and registration, a selection of a duration of the predetermined time period

14. The method of claim 11, further comprising:
aggregating the recorded outstanding debts using the configurable block chain.

15. The method of claim 14, further comprising:
marketing the aggregated recorded outstanding debts to one or more enrolled and registered debt buyers using an auction format.

16. A method, comprising:
integrating a debt collection and distribution service with an accounting software platform, the debt collection and distribution service including a configurable blockchain record;
enrolling a debt originator in the debt collection and distribution service, including obtaining an agreement from the debt originator that all outstanding debts stored by the debt originator in the accounting software platform are subject to automatic recording in the configurable blockchain record after expiration of a predetermined time period; and
automatically recording the outstanding debts in the configurable blockchain record after expiration of the predetermined time period.

17. The method of claim 16, further comprising:
aggregating the recorded outstanding debts using the configurable block chain.

18. The method of claim 17, further comprising:
marketing the aggregated recorded outstanding debts to an enrolled and registered debt buyer using an auction.

19. The method of claim 18, further comprising:
selling the aggregated recorded outstanding debts to the enrolled and registered debt buyer upon completion of the auction.

20. The method of claim 19, further comprising: providing access to the configurable blockchain to the enrolled and registered debt buyer upon completion of the sale of the aggregated recorded outstanding debts.
